(19) United States
(12) Patent Application Publication
(10) Pub. No.: US 2006/0164720 A1
(43) Pub. Date: Jul. 27, 2006

(54) Multilayer interference filter, manufacturing method for multilayer interference filter, solid-state imaging device and camera

(75) Inventors: Shinji Yoshida, Takatsuki-shi (JP); Yuichi Inaba, Moriguchi-shi (JP); Masahiro Kasano, Takatsuki-shi (JP)

Correspondence Address: MCDERMOTT WILL & EMERY LLP, 600 13TH STREET, N.W., WASHINGTON, DC, 20005-3096, US

(73) Assignee: Matsushita Electric Industrial Co., Ltd.

(21) Appl. No.: 11/337,599

(22) Filed: Jan. 24, 2006

(30) Foreign Application Priority Data
Jan. 24, 2005 (JP) 2005-016137

(51) Int. Cl. F21V 9/04

(52) U.S. Cl. 359/359

(57) ABSTRACT

A color filter is made from a silicon nitride, and has a multilayer structure including a silicon nitride layer and an airlayer. A multilayer film that selectively transmits green light has a seven-layer structure, in which two silicon nitride layers and one air layer is formed both above and below a spacer layer which is the air layer. On the other hand, each of a multilayer film that selectively transmits red light and a multilayer film that selectively transmits blue light has a silicon nitride layer as the spacer layer, and two silicon nitride layers and two air layers are formed both above and below the spacer layer. The silicon nitride layer is held by a holding part at a periphery thereof. Also, a hole is formed between multilayers for a manufacturing reason.

### CROSS-REFERENCE TO RELATED APPLICATIONS

This application is based on application NO. 2005-016137 filed in Japan, the contents of which are hereby incorporated by reference.

### BACKGROUND OF THE INVENTION

(1) Field of the Invention

The present invention relates to a multilayer interference filter, a manufacturing method for the multilayer interference filter, a solid-state imaging device and a camera. The present invention particularly relates to a technique to improve the ability of the multilayer interference filter to separate wavelengths, and widen the passband of the multilayer interference filter.

(2) Description of the Related Art

In digital cameras having been developed in recent years, a pigment-type color filter is used for a color separation, based on absorbing spectrums of organic pigment particles. FIG. 1 is a sectional view showing the structure of a solid-state imaging device that includes a pigment-type color filter.

As FIG. 1 shows, a solid-state imaging device 8 includes a p-type semiconductor layer 802, a photodiode 803, an isolation region 804, an insulation layer 805, a light-blocking film 806, color filter 807 and a microlens 808, which are layered on an n-type semiconductor layer 801. The photodiode 803 is isolated from each other by the isolation region 804. The light-blocking film 8 is formed within the insulation layer 805. The light-blocking film 8 blocks light so that only light that has passed through a color filter that corresponds to a photodiode can enter the photodiode.

In the solid-state imaging device 8 having the stated structure, the microlens 808 collects an incident light, and the color filter 807 transmits, for each pixel, only light having a predetermined wavelength corresponding to red, green or blue. Then, the photodiode 803 receives the light.

To realize a high spectral sensitivity, the thickness of the color filter 807 is approximately 1.5-2.0 μm. The diameter of each pigment particle included in the color filter 807 is approximately 0.1 μm (See “Kotai Satsuzo Soshi No Kiso (Fundamentals of Solid-state Imaging Device)” published by Nihon Riko Shuppan Kai, written by Ando and Komobuchi, edited by Eizo Joho Media Gakkai (The institute of Image Information and Television Engineers), December 1999, pp. 183-188).

To miniaturize the pixels in such a solid-state imaging device, it is necessary to miniaturize the diameter of the pigment particles included in the filter. However, there is a limit to the miniaturization. Also, the absorbance is determined by the product of the absorption coefficient and the film thickness. Therefore, the ability of the spectral separation decreases as the film thickness decreases. Furthermore, it becomes difficult to miniaturize the pigment particles and evenly disperse the particles in the color filter 807. This might deteriorate the spectral sensitivity and cause inconsistency in color.

To solve such problems, a color filter using a multilayer interference filter has been proposed. The multilayer interference filter is a color filter which is structured by films having a high refractive index and films having a low refractive index, which have substantially the same optical thickness and are layered alternately. This multilayer interference filter mainly reflects light whose wavelength is four times the optical thickness of each layer.

Therefore, each film is called a ¼ wavelength film. In the case where the multilayer interference filter includes a film as a spacer layer, whose film thickness is different from each film, the multilayer interference filter transmits light having a wavelength in accordance with the optical thickness of the spacer layer.

FIG. 2 is a sectional view showing the structure of the multilayer interference filter. As FIG. 2 shows, the multilayer filter 9 is structured by films 901 having a high refractive index and films 902 having a low refractive index, which are layered alternately. The optical thickness of each layer is approximately 137.5 nm. The multilayer interference filter 9 also includes a spacer layer 903 whose optical thickness is different from the layers 901 and 902. The optical thickness of the spacer layer 903 is 275 nm.

FIG. 3 is a graph showing a spectrum of the multilayer interference filter 9. As FIG. 3 shows, the multilayer interference filter 9 mainly blocks light whose wavelength is four times the optical thickness of each of the layers 901 and 902. In other words, the multilayer interference filter 9 blocks light whose wavelength is included in a wavelength band from 500 nm to 600 nm. The multilayer interference filter 9 transmits light whose wavelength is substantially twice the optical thickness of the spacer layer 903, which is a wavelength of 550 nm and its vicinity. Here, note that the multilayer interference filter 9 would have the same spectral characteristic, regardless of which of a material having a high refractive index and a material having a low refractive index is used for the spacer layer 903.

In recent years, as the number of the pixels used in a solid-state imaging device has been increased, the thickness of the color filter has been desired to be thinner. To meet this demand, it is required to reduce the number of the layers included in the multilayer interference filter.

Regarding the multilayer interference filter, the peak value of the transmission decreases as the number of the layers included therein decreases. Therefore, to improve the peak value of the transmission, it is required to widen the difference between the refractive index of the high refractive index material and the low refractive index material. If the difference is widened, the peak value of the transmission and the ability of the spectral separation increase.

As the low refractive index material included in the multilayer interference filter, glass or quartz is often used. As the high refractive index material, mono titanium dioxide (TiO₂) or ditantalum pentoxide (Ta₂O₅) is commonly used.

However, to make the multilayer interference filter even thinner, it is necessary to use materials of which the difference of the refractive indexes is larger, and thereby improve the ability of the spectral separation. Otherwise, it is impossible to avoid the deterioration of the spectral sensitivity of the imaging device and the inconsistency in color, which are caused due to the thinned multilayer interference filter.

### SUMMARY OF THE INVENTION

The present invention is made to solve the above-described problem. The object of the present invention is to provide a multilayer interference filter having a high ability of the spectral separation and a wide passband, a solid-state imaging device using the multilayer interference filter, and a method for manufacturing the multilayer interference filter.

The above object is fulfilled by a multilayer interference filter, comprising: a plurality of solid layers, each having substantially a same optical thickness and being made from a same material; and a plurality of gas layers, an optical thickness of each gas layer being a same as the optical thickness of each solid layer, wherein a refractive index of each solid layer is different from a refractive index of each gas layer, and the solid layers and the gas layers are layered alternately.

Since the refractive index of a gas is lower than the refractive index of a solid, the stated structure can realize a large refractive index difference between the high refractive index layer and the low refractive index layer. Accordingly, the stated structure can reduces the number of layers included in the multilayer interference filter, and realize a wide passband and a high ability of spectral separation.

Each solid layer may be made from a dielectric material. It is preferable that the dielectric material is any of silicon dioxide, trisilicon tetranitride, silicon oxide nitride, titanium dioxide and ditantalum pentoxide. The stated structure can realize a large refractive index difference between the high refractive index layer and the low refractive index layer to obtain a color filter having a high ability of spectral separation.

A multilayer interference filter according to the present invention may further comprise a holding part that holds the solid layers by connecting the solid layers with each other, wherein the solid layers and the holding part may be made from the same material.

This simplifies the structure of the multilayer interference filter. Accordingly, the manufacturing process of the multilayer interference filter can be simplified, and the manufacturing cost can be reduced. This means that the multilayer interference filter can be provided at a low price.

A manufacturing method for the multilayer interference filter according to the present invention is a manufacturing method for a multilayer interference filter in which a plurality of solid layers and a plurality of gas layers, each having substantially a same optical thickness, are layered alternately, the manufacturing method comprising: a first step of forming a first solid layer; a second step of forming a sacrifice layer on the first solid layer, using a material different from a material of the first solid layer; a third step of shaping the sacrifice layer so as to have a shape of a gas layer that is to be formed on the first solid layer; a fourth step of forming a second solid layer so as to cover the first solid layer and the sacrifice layer; a fifth step of flattening an upper surface of the second solid layer; and a sixth step of removing the sacrifice layer after forming the plurality of solid layers. With the stated method, it becomes possible to easily manufacture a multilayer interference filter in which the refractive index difference between the high refractive index layer and the low refractive index layer is large. Accordingly, it becomes possible to realize a stable multilayer structure.

The sixth step may further include: a seventh step of forming an opening, which reaches the sacrifice layer at a lowest level, in an upper surface of the multilayer interference filter; and an eighth step of supplying an etching gas via the opening to remove the sacrifice layer. With the stated method, it becomes possible to easily form the gas layer. Accordingly, it becomes possible to shorten the time required for completing the multilayer interference filter, and to reduce the manufacturing cost of the multilayer interference filter.

The seventh step may form a plurality of openings that sandwich, in a plan view of the multilayer interference filter, a portion of the sacrifice layer where is to be the gas layer. This enables the etching gas to be circulated throughout the whole sacrifice layer. Accordingly, it becomes possible to surely remove the sacrifice layer, and properly form the gas layer. Therefore, it becomes possible to manufacture a multilayer interference filter having a high ability of spectral separation.

A solid-state imaging device according to the present invention is a solid-state imaging device in which photoelectric transducers are two-dimensionally arranged, the solid-state imaging device comprising: a multilayer interference filter operable to perform a spectral separation on incident light to the photoelectric transducers, wherein the multilayer interference filter includes: a plurality of solid layers, each having substantially a same optical thickness and being made from a same material; and a plurality of gas layers, an optical thickness of each gas layer being same as the optical thickness of each solid layer, and the solid layers and the gas layers are layered alternately. With the stated structure, the color filter can be thinned and the solid-state imaging device can be miniaturized. Accordingly, high-resolution images can be obtained.

A camera according to the present invention is A camera having a solid-state imaging device in which photoelectric transducers are two-dimensionally arranged, the camera comprising: a multilayer interference filter operable to perform a spectral separation on incident light to the photoelectric transducers, wherein the multilayer interference filter includes: a plurality of solid layers, each having substantially a same optical thickness and made from a same material; and a plurality of gas layers, an optical thickness of each gas layer being same as the optical thickness of each solid layer, and the solid layers and the gas layers are layered alternately. With the stated structure, since a thin-type color filter that can be manufactured at a low cost is used, a camera that realizes a high-resolution and high-quality image can be obtained at a low cost regardless of whether the camera is a still camera or a video camera.

To increase the refractive index difference between the high refractive index layer and the low refractive index layer, a material having a higher refractive index is required to be used as the high refractive index material.

However, generally, the refractive index of a high refractive index material greatly changes as the wavelength changes, and therefore a sufficient ability of spectral separation can not be obtained. Also, the light absorption may be caused in a short wavelength region around the 400 nm, which means that such a high refractive index material is not suitable as a material of a color filter.

Therefore, it is preferable that a material having a lower refractive index is used as the low refractive index material. Especially, if a low refractive index gas, such as an air used in the present invention, is used as the low refractive index material, it is easy to increase the refractive index difference at a low cost. As described above, according to the present invention, a multilayer interference filter having a wide passband and a high ability of the spectral separation can be provided at a low cost.

### BRIEF DESCRIPTION OF THE DRAWINGS

These and the other objects, advantages and features of the invention will become apparent from the following description thereof taken inconjunction with the accompanying drawings which illustrate a specific embodiment of the invention. In the drawings:

FIG. 1 is a sectional view showing a structure of a solid-state imaging device that includes a pigment-type color filter according to a conventional technique;

FIG. 2 is a sectional view showing a structure of a multilayer interference filter;

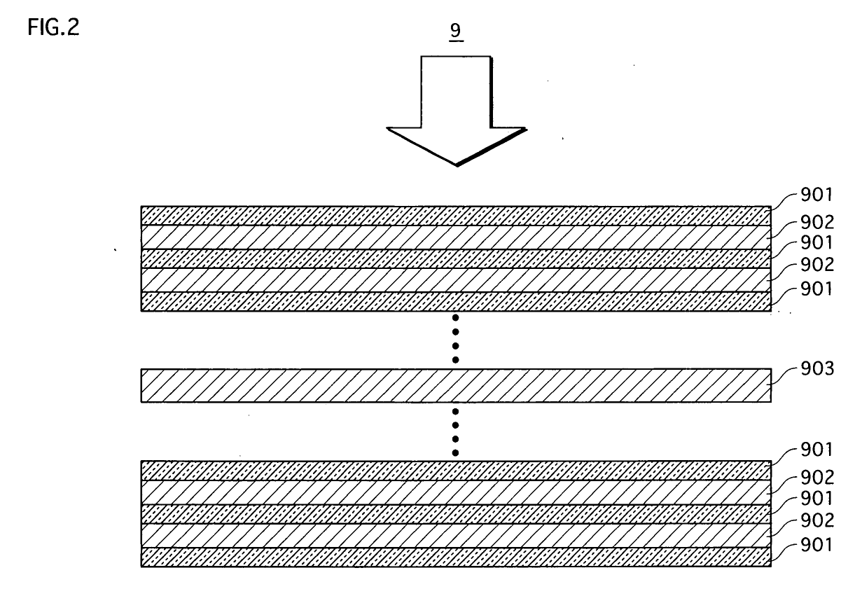

FIG. 3 is a graph showing a spectrum of a multilayer interference filter 9;

FIG. 4 is a block diagram showing a functional structure of an electronic still camera according to an embodiment of the present invention;

FIG. 5 is a sectional view showing a structure of a color filter that is included in a solid-state imaging device 103 according to an embodiment of the present invention;

FIG. 6 is a table showing a film thickness of each layer included in a color filter 2;

FIG. 7 is a graph showing a spectral characteristic of a spacer layer 20g, 20b and 20r included in a color filter 2 according to the present invention;

FIG. 8A to FIG. 8F are sectional views showing a manufacturing process of a color filter 2 according to the present invention;

FIG. 9A to FIG. 9C are sectional views showing a manufacturing process of a color filter 2 according to the present invention (continued from FIG. 8F);

FIG. 10A and FIG. 10B show a manufacturing process of a color filter 2 according to the present invention, and particularly showing a process for removing a sacrifice layer; and

FIG. 11 is a plan view showing a color filter 7 according to a modification (7) of the present invention.

### DESCRIPTION OF THE PREFERRED EMBODIMENT

The following describes a multilayer interference filter, an imaging device having the multilayer interference filter, and a method for manufacturing the multilayer interference filter according to a preferred embodiment of the present invention by taking an electronic still camera as an example.

[1] Structure of Electronic Still Camera

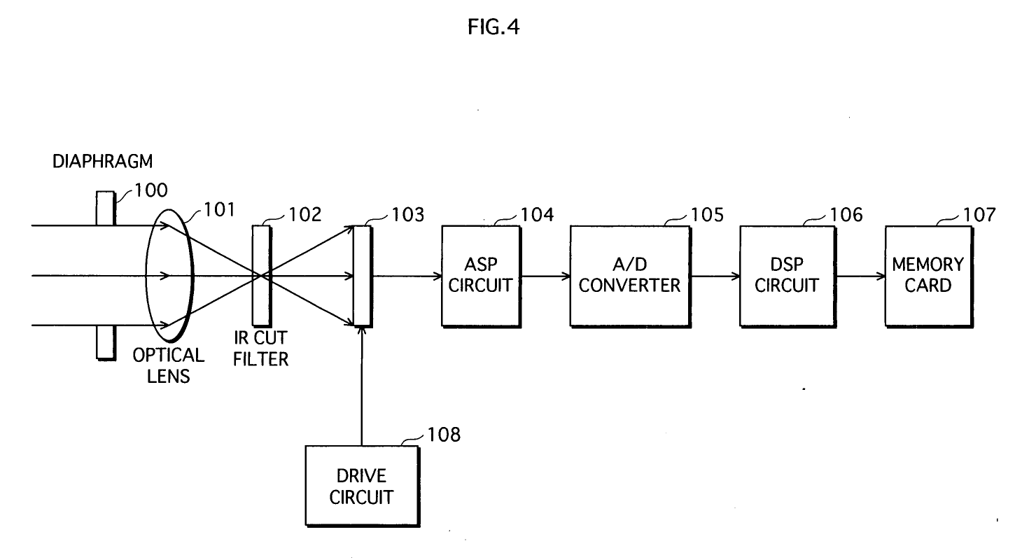

FIG. 4 shows a block diagram showing a functional structure of an electronic still camera according to an embodiment of the present invention. As FIG. 4 shows, a electronic still camera 1 includes a diaphragm 100, an optical lens 101, an infrared rays cut filter 102 (Hereinafter called the “IR cut filter 102”.), a solid-state imaging device 103, an analogue signal processing circuit 104 (Hereinafter called the “ASP circuit 104”.), an analogue to digital converter 105 (Hereinafter called the “A/D converter 105”.), a digital signal processing circuit 106 (Hereinafter called the “DSP circuit 106”.), a memory card 107 and a drive circuit 108.

The diaphragm 100 adjusts the amount of light incident on the optical lens 101. The diaphragm 100 includes two diaphragm blades. As the distance between the two diaphragm blades is increased, the amount of light incident on the optical lens 101 increases, and accordingly the amount of the light incident on the solid-state imaging device 103 increases. On the other hand, as the distance between the two diaphragm blades is decreased, the amount of the light incident on the solid-state imaging device 103 decreases.

The optical lens 101 receives light from the subject and forms an image on the solid-state imaging device 103. The IR cut filter 102 removes a long wavelength component of the light incident on the solid-state imaging device 103. The solid-state imaging device 103 is a so-called 1CCD image sensor, in which a color filter for filtering incident light is disposed on each of the photoelectric transducers which are two-dimensionally arranged.

The color filter is arranged in Bayer array, for instance. The solid-state imaging device 103 reads an electric charge according to a drive signal received from the drive circuit 108, and outputs an analogue imaging signal.

Here, note that light-receiving elements included in the solid-state imaging device 103 are two-dimensionally arranged with bias. In other words, some of the light-receiving elements are arranged to be closer to each other compared to the other light-receiving elements. This realizes a high resolution. Also, as described above, the light-receiving elements that are arranged to be closer to each other share a translucent layer and a collecting layer.

The ASP circuit 104 performs a correlated double sampling, a signal amplification, and so on on the analogue imaging signal output by the solid-state imaging device 103. The A/D converter 105 converts the signal output by the APS circuit 104 into a digital imaging signal. The DPS circuit 106 corrects the color shift of the digital imaging signal, and generates digital picture signal. The memory card 107 stores the digital picture signal.

[2] Structure of Solid-State Imaging Device 103

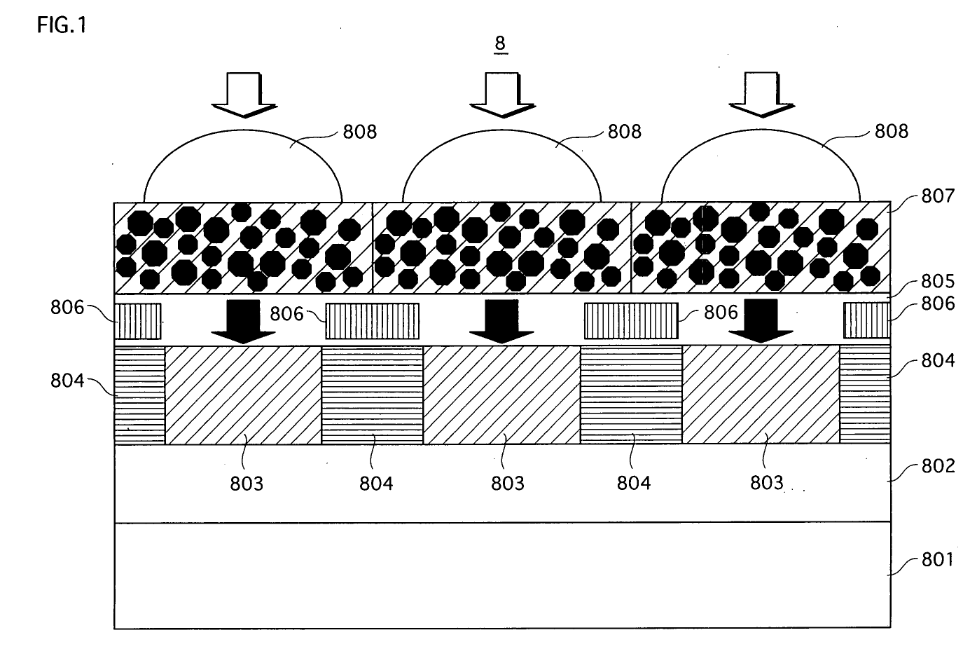

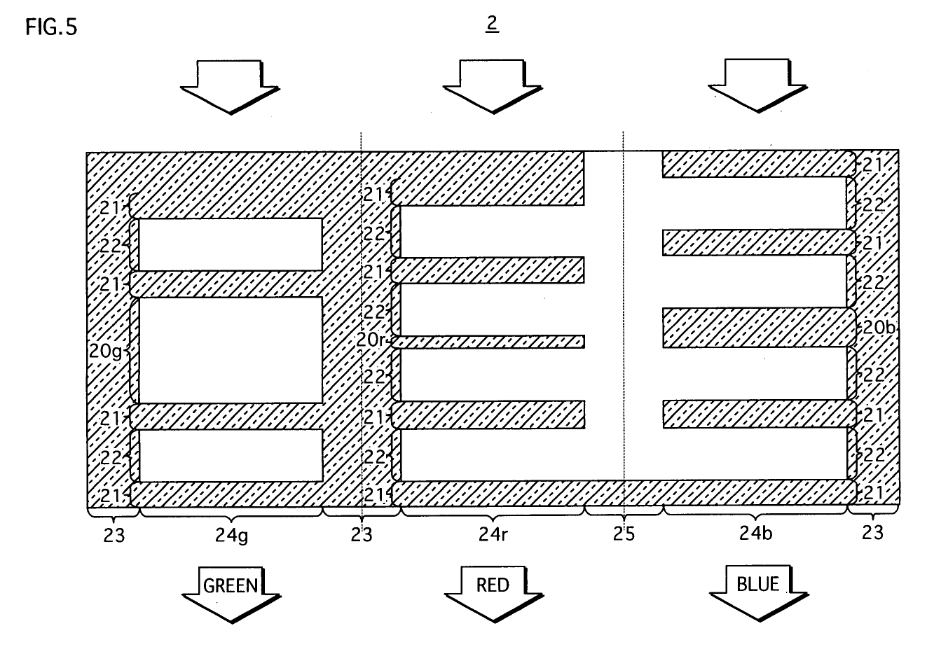

The solid-state imaging device 103 has roughly the same structure as the solid-state imaging device 8 according to the conventional technique, which is shown in FIG. 1. However, the structure of the color filter is different. FIG. 5 is a sectional view showing the structure of the color filter that is included in the solid-state imaging device 103. FIG. 5 illustrates the color filter, which corresponds to three pixels which each separates light having a different wavelength.

The color filter 2 is made from trisilicon tetranitride (Si₃N₄, hereinafter called silicon nitride), and having a multilayer film structure including a silicon nitride layer 21 and an air layer 22 as FIG. 5 shows.

A multilayer film 24g, which selectively transmits green light, has a seven-layer structure including a spacer layer 20g, and two silicon nitride layers 21 and one air layer 22 which are formed above and below the space layer 20g.

A multilayer film 24r, which selectively transmits red light, and a multilayer film 24b, which selectively transmits blue light, have a spacer layer 20r and a spacer layer 20b respectively. Two silicon nitride layers 21 and two air layers 22 are formed above and below each of the space layers 20r and 20b.

The silicon nitride layers 20g, 20b and 20r are held by holding parts 23 at their respective periphery. Also, between the multilayer films 24r and 24b, a hole 25 is formed for a manufacturing reason as described later.

The thickness of the silicon nitride layer 21 is 66.3 nm and the thickness of the air layer 22 is 132.5 nm. The refractive index of the silicon nitride layer 21 is generally “2”, and the refractive index of the air layer 22 is generally “1”. Therefore, the silicon nitride layer 21 and the air layer 22 have the substantially the same optical thickness, and the color filter 2 reflects light having a predetermined wavelength, in which light having a wavelength of 530 nm is mainly reflected.

The optical thicknesses of the spacer layers 20g, 20b and 20r are respectively 265 nm, 55 nm and 215 nm. The spacer layers 20g, 20b and 20r transmit light of green, blue and red respectively.

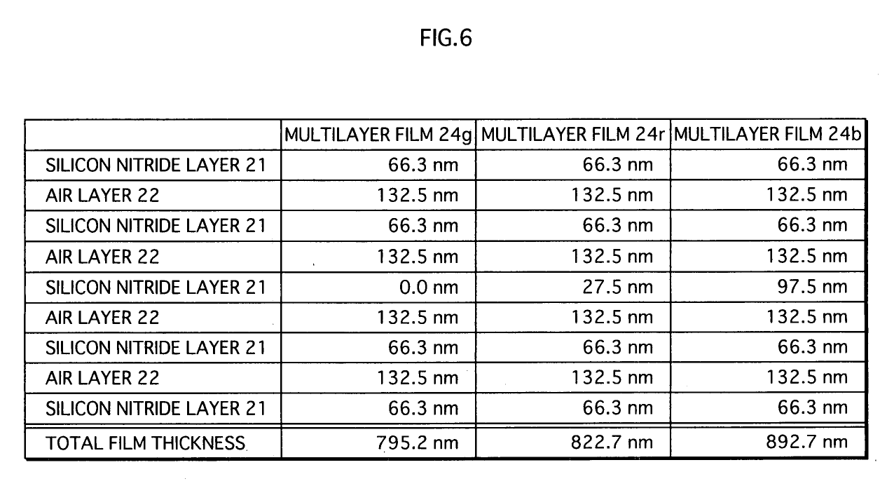

FIG. 6 is a table showing the film thickness of each layer included in the color filter 2. With use of the multilayer interference filter, the wavelength of light that the filter transmits can be controlled only by changing the thickness of the spacer layer. The film thicknesses of the multilayers 24g, 24r and 24b are all less than 1 μm. This is a suitable size for miniaturizing the solid-state imaging device.

[3] Spectral Characteristic of Color Filter 2

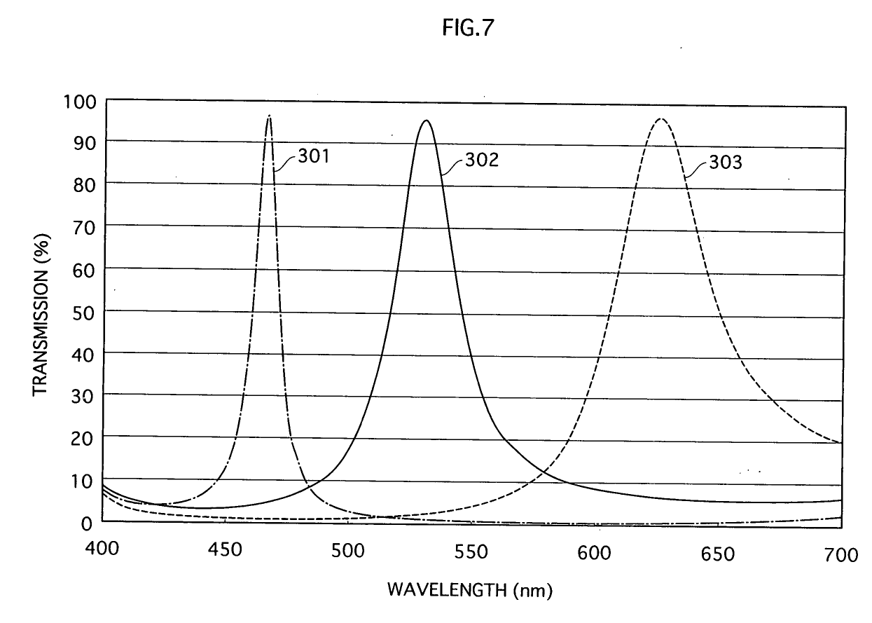

FIG. 7 shows the spectral characteristic of the color filter 2, in which the spectral characteristics of the spacer layer 20g, 20b and 20r are separately illustrated. In FIG. 7, the graph 301 shows the spectral characteristic of the multilayer that includes the spacer layer 20b. The graphs 302 and 303 show the spectral characteristics of the spacer layers 20g and 20r respectively.

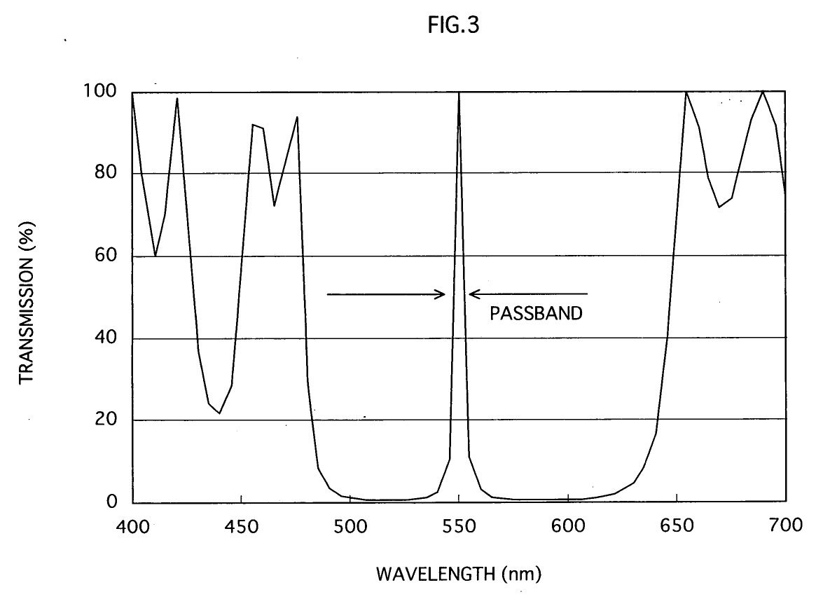

As FIG. 7 shows, the spectral characteristic for each color indicates a wider passband than that of the conventional technique (see FIG. 3). Regarding the ability of spectral separation, the transmission rate is not less than 95% as to the wavelength to be transmitted, and is not more than 10% as to the wavelength to be reflected. These values are comparable to those of the conventional technique.

[4] Manufacturing Method for Color Filter 2

The manufacturing method for the color filter 2 is described next.

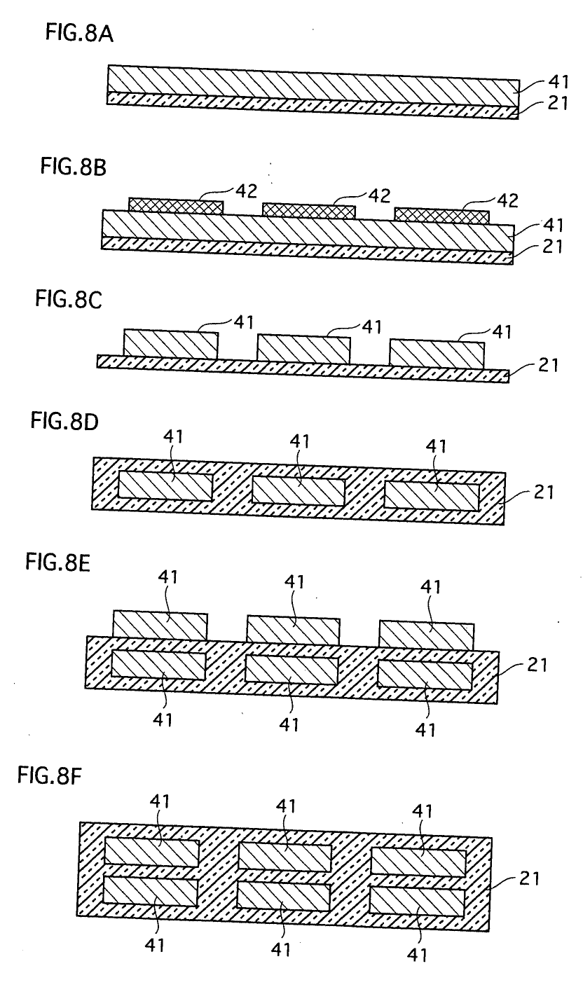

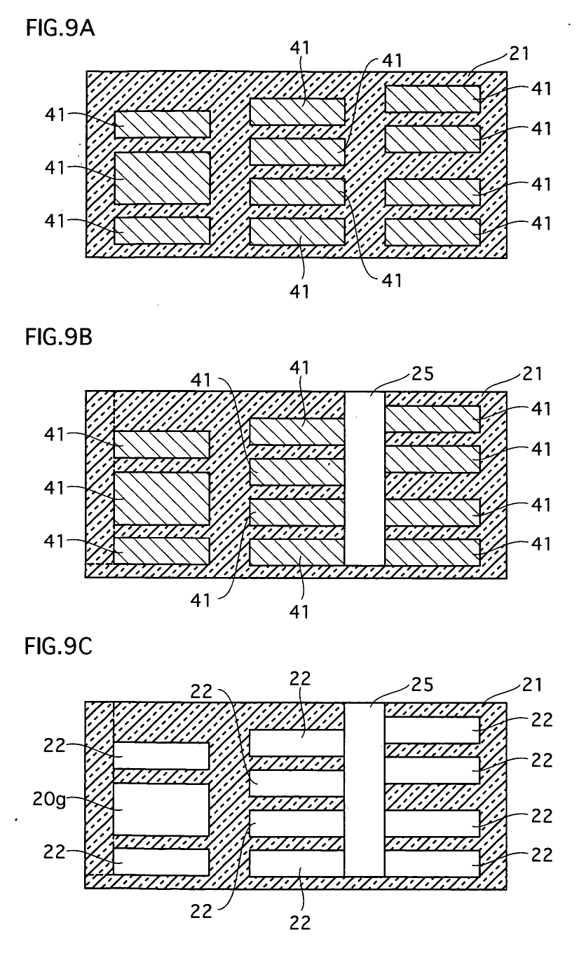

FIG. 8A to FIG. 8F and FIG. 9A to FIG. 9C show a manufacturing procedure of the color filter 2. Each figure shows the cross section of the color filter 2. The manufacture procedure progresses in the order from FIG. 8A to FIG. 8F, and FIG. 9A to FIG. 9C. Firstly, as FIG. 8A shows, a sacrifice layer 41 is formed on the lowermost silicon nitride layer 21. Next, a resist 42 is formed on the sacrifice layer 41. Then, patterning is performed on the sacrifice layer 41, using lithography (FIG. 8B). As a material for the sacrifice layer 41, poly-silicon may be used. Also, silicon dioxide (SiO₂) film may be used as the sacrifice layer 41.

Next, a silicon nitride film is formed on the silicon nitride layer 21 and the sacrifice layer 41 (FIG. 8C), and the silicon nitride layer 21 on the sacrifice layer 41 is ground and flattened using a CMP (Chemical Mechanical Polishing) so as to have a desired thickness (FIG. 8D). Here, note that not only the CMP but also a Resist Etch-Back may be used for the flattening. Further, an overall etching may be performed after the CMP processing is finished.

Then, another sacrifice layer 41 is formed on the flattened silicon nitride layer 21 (FIG. 8E), and another silicon nitride film 21 is formed in the same manner as described above, and ground (FIG. 8F) . Here, note that the silicon nitride film 21 is ground so as to have a film thickness of the thickest spacer layer.

Regarding other pixels, the silicon nitride layer 21 is etched to have a desired thickness by dry etching. Here, parts where are not to be etched should be masked using resists.

After the spacer layers 20g, 20b and 20r are formed, the above described procedure is repeated to obtain the color filter 2 in which the portions to be the air layers 22 are formed as the sacrifice layers 41 (FIG. 9A). Next, to remove the sacrifice layers 41, an etching hole 25 is formed (FIG. 9B).

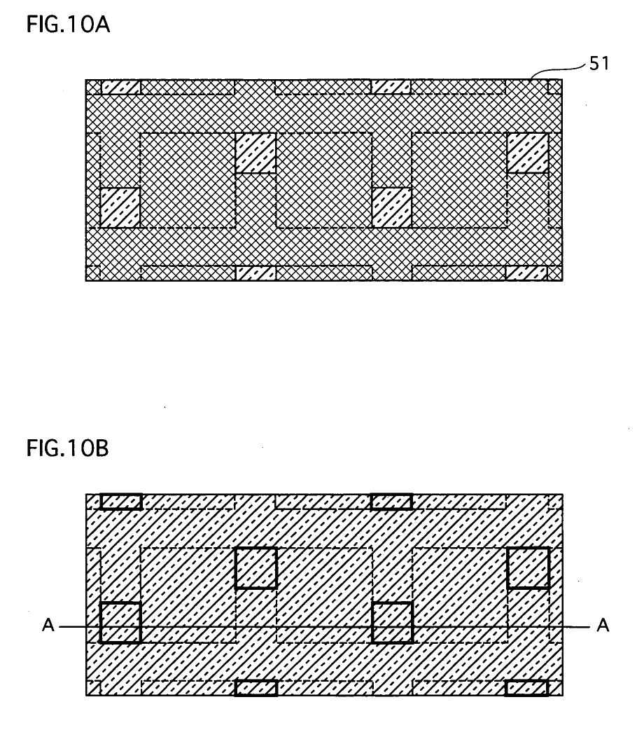

FIG. 10A and FIG. 10B are plan views showing the manufacturing procedure for the color filter 2. Firstly, an etching mask 51 is formed on the silicon nitride layer 21. This etching mask 51 covers the silicon nitride layer 21 except for the part where the etching holes 25 are to be formed (FIG. 10A).

In FIG. 10A, the broken lines indicate locations where the sacrifice layer 41 is buried. The etching holes 25 are formed so as to diagonally oppose each other and sandwich the sacrifice layer 41 in the plan view. Then, the sacrifice layer 41 is removed using an etching gas to form the air layer 22. FIG. 9C is a sectional view cut along the line A-A shown in FIG. 10B.

Here, if the sacrifice layer is a silicon nitride film, a hydrofluoric acid vapor or a mixture vapor of hydrofluoric acid and alcohol may be used for the etching. If this is the case, methanol is suitable as the alcohol used for the etching. If the sacrifice layer is made from poly-silicon, xenon fluoride. (XeF₂) and a fluorine gas (F₂) are suitable. With use of these etching gases, an isotropic etching is performable.

The color filter 2 can be manufactured at a low cost in the above-described manner.

[5] Modifications

The present invention is described above based on the embodiment. However, the present invention is not limited to the embodiment. The followings are possible modifications.

(1) The above-described embodiment explains the case where the silicon nitride is used as the high refractive index material. However, as a matter of course, the present invention is not limited to this. Titanium dioxide (TiO₂) may be used as the high refractive index material. The refractive index of titanium dioxide is approximately “2.5”, which is very large. Also, titanium dioxide does not absorb much of visible light, and therefore suitable for the color filter. If titanium dioxide is used as the high refractive index material, it is possible to obtain large refractive index difference, which is approximately “1.5”. As a result, a color filter having a high ability of spectral separation can be realized.

Also, silicon oxide, silicon nitride, silicon oxide nitride (SiON) or tantalum oxide maybe used as the high refractive index material. For instance, if the high refractive index layer is a silicon nitride film, the refractive index of the silicon nitride is approximately “2”, and the refractive index difference is “1”, which is the same as the embodiment.

Silicon oxide is an excellent material which does not absorb a whole range of the visible light, and rarely causes dispersion. If silicon oxide is used as the high refractive index material, a color filter can be manufactured at a low cost by the silicon process in the same manner as the above-described embodiment.

The high refractive index material used for carrying out the present invention preferably has a refractive index higher than “1.4”. The higher the refractive index is, the higher ability of the spectral separation can be obtained. Also, it is preferable that the material absorbs an extremely small amount of visible light.

(2) The above-described embodiment explains the case where the air layer is used as the low refractive index layer. However, as a matter of course, the present invention is not limited to this. For instance, a gas layer, within which a gas other than air is enclosed, may be used as the low refractive index layer. Of course, it is preferable that the refractive index of the gas is as low as possible, and the gas is transparent and colorless. Also, instead of the air layer, a vacuum layer may be used to achieve the same effect.

(3) The above-described embodiment explains the case where two high refractive index layers and two low refractive index layers are formed above and below the spacer layer (the multilayer films 24r and 24b), or the case where two high refractive index layers and one low refractive index layer is formed above and below the spacer layer (the multilayer film 24g). However, as a matter of course, the present invention is not limited to this. The number of the layers may be modified.

However, as described above, if the number of the layer of the multilayer films increases, the passband becomes narrow. Further, this does not meet the demand for the miniaturization of the color filter. Therefore, it is preferable that the number of the layer of the multilayer films is not too large. For instance, the number of pairs of the high refractive index layer and the low refractive index layer, which are formed on one side of the spacer layer, is preferably not more than three. The advantage of the present invention is that it can increase the peak value of the transmission and heighten the ability of the spectral separation with a small number of multilayer films.

(4) The above-described embodiment explains the case where the high refractive index layer 21 and the holding part 23 are made from the same material. However, as a matter of course, the present invention is not limited to this. Different material may be used, instead. If a material harder than the high refractive material is used as the holding part 23, it becomes possible to more surely maintain the positional relation between the high refractive index layer and the low refractive index layer 22. Meanwhile, if the same material is used, it can be an advantage because the manufacturing process can be simplified.

(5) The above-described embodiment explains the case where the ¼ wavelength film and the spacer layer is made from the same material. However, as a matter of course, the present invention is not limited to this. Different material may be used. However, if the same material is used, the manufacturing process can be simplified.

(6) The above-described embodiment explains the case where the optical thickness of each filter included in the multilayer interference filter is the same, except for the spacer layer. However, as a matter of course, the optical thickness of the present invention is not limited to this. The multilayer interference filter changes the phase difference between the incident light and the reflected light to be ½ wavelength, and thereby causes interference between the incident light and the reflected light, by which the incident light and the reflected light cancel out each other. Accordingly, light having a predetermined wavelength is reflected by the multilayer interference filter. To cause this interference, the optical thickness is required to be

$$( \frac{1}{2} n + \frac{1}{4} ) λ ,$$

where n is an integer not less than 0, and n may be different for each layer.

(7) The above-described embodiment explains the case where the etching gas used for etching the sacrifice layer 41 is supplied from a diagonal direction in the plan view of the sacrifice layer 41. However, the present invention is not limited to this. The following is a possible modification.

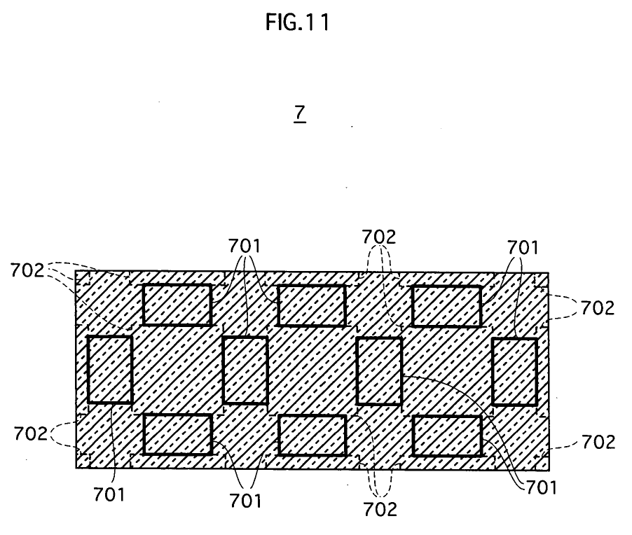

FIG. 11 is a plan view showing a color filter 7 according to the modification of the present invention. In FIG. 11, each etching hole 701 is formed so as to contact with any of the four sides of the multilayer film 702, which is in the shape of a rectangle in a plan view. However, to hold the solid layer included in the multilayer film 702, the etching hole 701 is not formed at the four corners of the multilayer film 702. As a result, the area where the air layer included in the multilayer film 702 contacts with the etching hole 701 becomes large. Accordingly, the sacrifice layer can be more surely removed.

Although the present invention has been fully described by way of examples with reference to the accompanying drawings, it is to be noted that various changes and modifications will be apparent to those skilled in the art. Therefore, unless such changes and modifications depart from the scope of the present invention, they should be construed as being included therein.

What is claimed is:

1. A multilayer interference filter, comprising:
a plurality of solid layers, each having substantially a same optical thickness and being made from a same material; and
a plurality of gas layers, an optical thickness of each gas layer being a same as the optical thickness of each solid layer, wherein
a refractive index of each solid layer is different from a refractive index of each gas layer, and
the solid layers and the gas layers are layered alternately.

2. The multilayer interference filter of claim 1, wherein each solid layer is made from a dielectric material.

3. The multilayer interference filter of claim 2, wherein the dielectric material is any of silicon dioxide, trisilicon tetranitride, silicon oxide nitride, titanium dioxide and ditantalum pentoxide.

4. The multilayer interference filter of claim 1, further comprising:
a holding part that holds the solid layers by connecting the solid layers with each other, wherein
the solid layers and the holding part are made from the same material.

5. A manufacturing method for a multilayer interference filter in which a plurality of solid layers and a plurality of gas layers, each having substantially a same optical thickness, are layered alternately, the manufacturing method comprising:
a first step of forming a first solid layer;
a second step of forming a sacrifice layer on the first solid layer, using a material different from a material of the first solid layer;
a third step of shaping the sacrifice layer so as to have a shape of a gas layer that is to be formed on the first solid layer;
a fourth step of forming a second solid layer so as to cover the first solid layer and the sacrifice layer;
a fifth step of flattening an upper surface of the second solid layer; and
a sixth step of removing the sacrifice layer after forming the plurality of solid layers.

6. The manufacturing method of claim 5, wherein
the sixth step further includes:
a seventh step of forming an opening, which reaches the sacrifice layer at a lowest level, in an upper surface of the multilayer interference filter; and
an eighth step of supplying an etching gas via the opening to remove the sacrifice layer.

7. The manufacturing method of claim 6, wherein
the seventh step forms a plurality of openings that sandwich, in a plan view of the multilayer interference filter, a portion of the sacrifice layer where is to be the gas layer.

8. A solid-state imaging device in which photoelectric transducers are two-dimensionally arranged, the solid-state imaging device comprising:
a multilayer interference filter operable to perform a spectral separation on incident light to the photoelectric transducers, wherein
the multilayer interference filter includes:
a plurality of solid layers, each having substantially a same optical thickness and being made from a same material; and
a plurality of gas layers, an optical thickness of each gas layer being same as the optical thickness of each solid layer, and
the solid layers and the gas layers are layered alternately.

9. A camera having a solid-state imaging device in which photoelectric transducers are two-dimensionally arranged, the camera comprising:
a multilayer interference filter operable to perform a spectral separation on incident light to the photoelectric transducers, wherein
the multilayer interference filter includes:
a plurality of solid layers, each having substantially a same optical thickness and made from a same material; and
a plurality of gas layers, an optical thickness of each gas layer being same as the optical thickness of each solid layer, and
the solid layers and the gas layers are layered alternately.
